(19) United States
(12) Patent Application Publication
(10) Pub. No.: US 2006/0136783 A1
(43) Pub. Date: Jun. 22, 2006

(54) Automatically reducing test program size

(75) Inventors: Simon John Craske, Cambridge (GB); Eric Jason Furbish, Austin, TX (US); Jonathan William Brawn, Austin, TX (US)

Correspondence Address: NIXON & VANDERHYE, PC, 901 NORTH GLEBE ROAD, 11TH FLOOR, ARLINGTON, VA, 22203, US

(73) Assignee: ARM LIMITED, Cambridge (GB)

(21) Appl. No.: 11/003,019

(22) Filed: Dec. 3, 2004

(51) Int. Cl. G06F 11/00

(52) U.S. Cl. 714/38

(57) ABSTRACT

Test program sequences of a quasi-minimum length which still produce a predetermined event are automatically generated by a genetic algorithm which requires that mutated programs continue to produce the predetermined event whilst favouring programs of a shorter length. Candidate test program sequences are mutated by removing respective randomly selected programs therefrom and then evaluated using an instruction set simulator, other simulator, real hardware or the like to detect whether the predetermined event is still produced. The predetermined event can take a variety of different forms, such as test failure, critical path stimulation, power consumption reaching predetermined levels, a temporal sequence of events, a concurrent combination of events or the like.

### BACKGROUND OF THE INVENTION

1. Field of the Invention

This invention relates to the field of data processing systems. More particularly, this invention relates to reducing the size of test programs whilst ensuring that those test programs still produce a predetermined event.

2. Description of the Prior Art

It is known to utilise test programs to perform test operations upon data processing systems for various purposes. Such test programs may, for example, be used to validate the design or manufacture of a data processing apparatus. Another example would be to investigate critical timing path limitations, power consumption maxima or minima, particular combinations of events which stress other components within the overall system, etc. Test programs to investigate these types of event can be manually written by engineers who understand the data processing system under test and seek to produce the predetermined event that they wish to investigate. Alternatively, some test programs may be automatically generated, such as by the use of genetic algorithm techniques or random test instruction generation.

It is generally desirable for a variety of reasons that a test program should be short whilst still producing the predetermined event to be investigated. An example of a situation in which short test programs are particularly desirable is built-in self test in which on-chip memory storage is provided for the test programs and accordingly keeping the test program size small represents a significant saving in circuit overhead for the storage of those test programs on-chip.

### SUMMARY OF THE INVENTION

Viewed from one aspect the present invention provides a method of analyzing a test sequence of program instructions for an apparatus for processing data, said test sequence producing a predetermined event for said apparatus for processing data, said method comprising:

(i) forming a plurality of copies of said test sequence to serve as parent test sequences;

(ii) removing at least one program instruction from each of said parent test sequences to produce a plurality of candidate test sequences;

(iii) detecting if executing respective candidate test sequences continues to produce said predetermined event for said apparatus for processing data; and

(iv) if at least one of said candidate test sequences continues to produce said predetermined event for said apparatus for data processing, then using said at least one of said candidate test sequences to form parent test sequences; and

(v) repeating steps (ii), (iii) and (iv) until a termination condition is detected.

This technique provides a way in which a test program may be automatically reduced in size whilst still producing a predetermined event under investigation. One way of considering this technique is that it represents a genetic algorithm in which continuing to produce a predetermined event is required for survival between generations and there is a weighted selection in favour of shorter test programs. Such a genetic algorithm can be run for many iterations until the test program reaches a quasi-minimum length whilst still producing the required predetermined event.

It will be appreciated that the predetermined event to be tested could take a wide variety of different forms. The present technique is particularly useful when seeking to develop shorter tests which still produce test failure, stimulation of a critical path, power consumption reaching a predetermined level, occurrence of a predetermined temporal sequence of events and/or occurrence of a predetermined concurrent combination of events. Whilst the present technique is particularly useful in producing test programs to investigate such events, the technique is not limited to these events.

The termination of the iteration can be controlled in a variety of different ways. Particularly useful termination conditions are that no candidate test sequences produced the predetermined event or that one or more of the candidate test sequences which continues to produce the predetermined event falls below a predetermined length established as a desired target length.

If an iteration of the technique produces no candidate programs which still produce the predetermined event, then the system may revert to the parent test programs and reiterate these with a view to a different random removal of program instructions having a chance of producing a test sequence that will continue to produce the predetermined event.

In the context of a limiting condition in which none of the candidate test sequences are producing the predetermined event, then a useful termination condition is that such behaviour is exhibited for a continuous predetermined number of iterations whereupon the iterative process is terminated.

Whilst it will be appreciated that the instructions removed on each iteration can be selected in a variety of different ways, in preferred embodiments it is effective to randomly select the instruction to be removed from the different candidate programs. Such random selection is simple to provide and unlikely to suffer from the risk of an in-built bias in how the evolution is steered which could result from an attempt to use a more sophisticated way in which the instruction to be removed is selected.

Viewed from another aspect the present invention provides apparatus for processing data operable to analyze a test sequence of program instructions for an apparatus for processing data, said test sequence producing a predetermined event for said apparatus for processing data, said apparatus comprising logic operable to perform the steps of:

(i) forming a plurality of copies of said test sequence to serve as parent test sequences;

(ii) removing at least one program instruction from each of said parent test sequences to produce a plurality of candidate test sequences;

(iii) detecting if executing respective candidate test sequences continues to produce said predetermined event for said apparatus for processing data; and

(iv) if at least one of said candidate test sequences continues to produce said predetermined event for said apparatus for data processing, then using said at least one of said candidate test sequences to form parent test sequences; and

(v) repeating steps (ii), (iii) and (iv) until a termination condition is detected.

Viewed from a further aspect the present invention provides a computer program product bearing a computer program for controlling a computer to perform a method of analyzing a test sequence of program instructions for an apparatus for processing data, said test sequence producing a predetermined event for said apparatus for processing data, said method comprising:

(i) forming a plurality of copies of said test sequence to serve as parent test sequences;

(ii) removing at least one program instruction from each of said parent test sequences to produce a plurality of candidate test sequences;

(iii) detecting if executing respective candidate test sequences continues to produce said predetermined event for said apparatus for processing data; and

(iv) if at least one of said candidate test sequences continues to produce said predetermined event for said apparatus for data processing, then using said at least one of said candidate test sequences to form parent test sequences; and

(v) repeating steps (ii), (iii) and (iv) until a termination condition is detected.

The above, and other objects, features and advantages of this invention will be apparent from the following detailed description of illustrative embodiments which is to be read in connection with the accompanying drawings.

### BRIEF DESCRIPTION OF THE DRAWINGS

Embodiments of the invention will now be described, by way of example only, with reference to the accompanying drawings in which:

FIG. 1 schematically illustrates the iterative evolution of shorter test program sequences;

FIG. 2 is a flow diagram schematically illustrating the process described in FIG. 1; and

FIG. 3 is a diagram schematically illustrating a general purpose computer of the type which may be used to implement the above described techniques.

### DESCRIPTION OF THE PREFERRED EMBODIMENTS

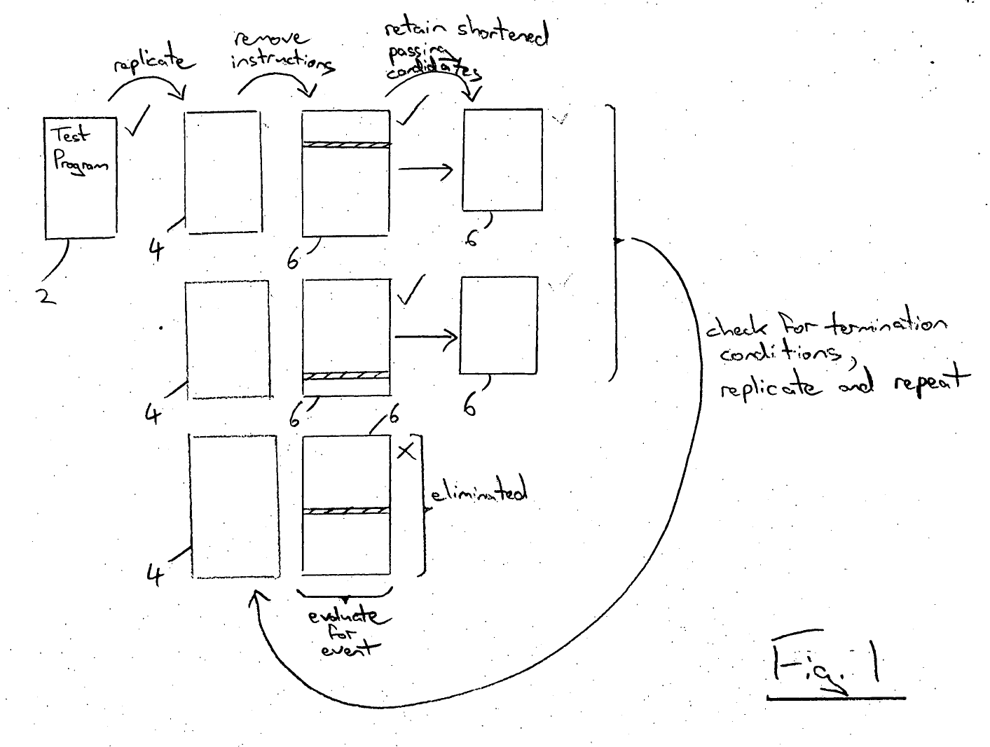

FIG. 1 illustrates a starting test program 2 which is known to produce a predetermined event when executed by a data processing apparatus, or when the execution of that test sequence is simulated. The test sequence could be provided with a view to investigating a wide variety of different types of behaviour of the data processing apparatus concerned. One example would be that the test sequence is produced to stimulate the data processing apparatus to adopt a broad and quasi-comprehensive range of state within its possible range of operational states. This type of test is used to try to ensure that a particular data processing apparatus design or implementation properly conforms to an expected architecture and expected behaviour in all states. Simulated execution of such a test sequence will result in a simulated resulting state and this can be compared with an expected resulting state. Differences detected indicate a test failure in the design or manufacture of the data processing apparatus. The test sequences can be very large and it is a skilled job to identify which portion of such a large test sequence is producing the test failure. The present technique is able to take such a failing test sequence and automatically reduce it in size to a quasi-minimum size which still produces the test failure. This eases the task of identifying the cause of the failure. Furthermore, such a shortened test can be reused during the further evolution of the design to ensure that the bug concerned does not re-enter the design.

Returning to FIG. 1, the initial test program 2 is replicated to form a plurality of parent programs 4, these parent programs 4 are then each subject to a mutation, being the removal of a randomly selected instruction therefrom. Each parent program 4 will typically have a different randomly selected program instruction removed from it. It may be possible or desired to remove multiple program instructions at each iteration either as a contiguous block or scattered within the parent program 4. The present example embodiment however illustrates the removal of a single randomly selected program instruction from each parent program 4. The resulting mutated programs are candidate test sequences 6 which are each subject to an evaluation to determine if they still produce the predetermined event of interest which was produced by the initial test program 2. The example previously discussed was a test checking for architectural conformance of a design or a particular manufactured implementation. Other examples of predetermined events which may be investigated in this way are stimulation of a critical path within a design, the power consumption of a design reaching particular levels, a predetermined temporal sequence of events occurring and/or a predetermined concurrent combination of events occurring. A variety of other predetermined events may also be investigated with the present technique.

When the candidate test sequences 6 are evaluated, two of these continue to produce the predetermined event and one does not. This behaviour is indicated by the ticks and crosses in FIG. 1. The evaluation may be the simulated execution of the candidate test sequences 6 using an instruction set simulator, an RTL simulator, a gate level simulator or the like. The evaluation could also take the form of actual execution on a physical device whether that be a final manufactured device or an FPGA device.

The two candidate test sequences which survive are retained whilst the other candidate test sequence is discarded. Candidate test sequences are discarded if they either do not continue to produce the predetermined event or unpredictably produce the predetermined event.

At this stage two candidate test sequences which are both shorter than the original test sequence 2 have been produced and both of these candidate test sequences still produce the predetermined event. The system then checks for termination conditions. These termination conditions may be that no suitable candidate test sequences still showing the predetermined event have been found, that the candidate test sequences have reached a desired level of shortness, or other termination conditions. If the termination conditions are not met, then the passing candidate test sequences are then used as parent test sequences for and the iterative process repeated. The passing candidate test sequences can be considered to be a population of candidate test sequences from among which parent test sequences for a next generation are selected in accordance with genetic algorithm techniques. At a simple level all the candidate test sequences could be reused as parents, but in other embodiments there may be a tournament between the candidate test sequences that have passed to establish a ranking in their fitness to serve as parents for the next generation and a selection then made from amongst these ranked parents.

If no passing candidate test sequences were produced, then the parent test sequences from the previous generation may be reinstated and reused with different randomly selected program instructions being likely to be removed therefrom upon the next iterative generation. If such reinstatement occurs a predetermined number of times without any passing candidate test sequences being produced, then this may be detected as another form of termination condition.

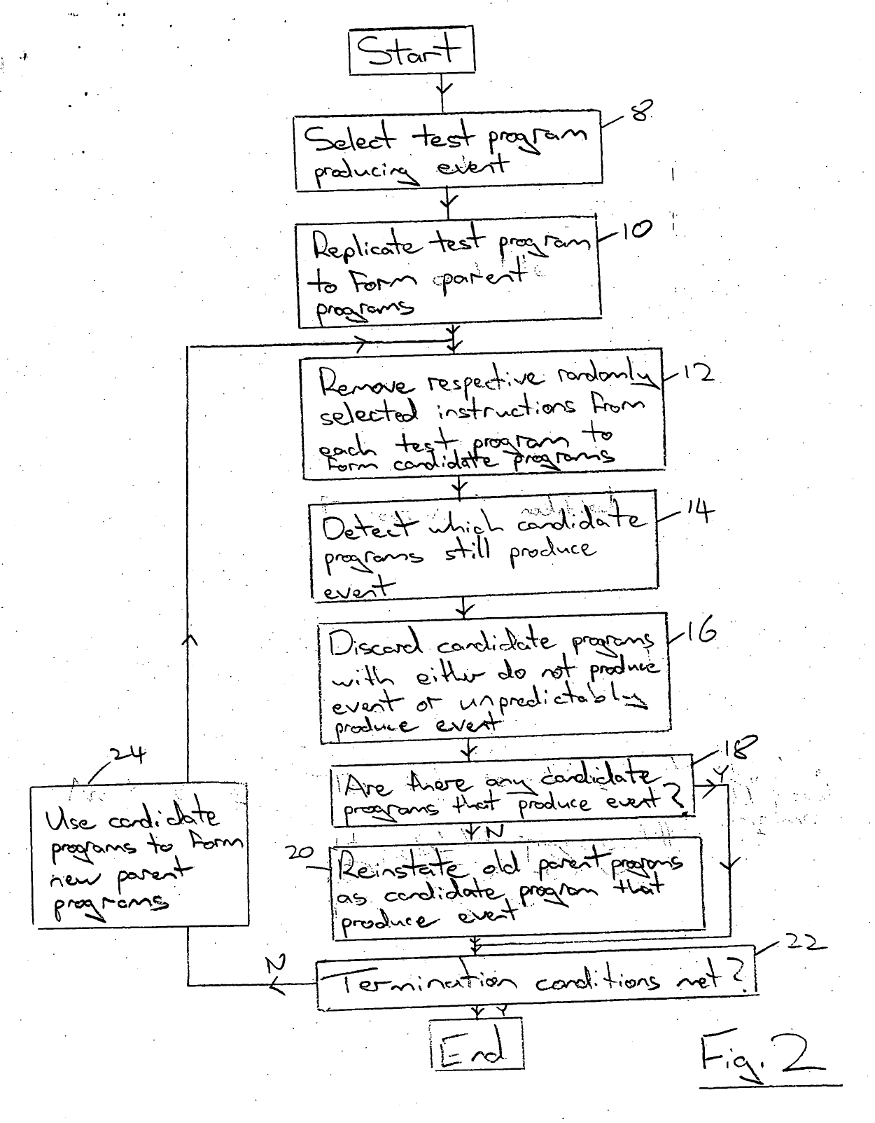

FIG. 2 is a flow diagram schematically illustrating the behaviour of one embodiment of the present technique. At step 8 a test program (sequence) producing a predetermined event is selected. At step 10 this program is replicated to form a population of the parent programs. At step 12 this population of parent programs is mutated by removing respective randomly selected instructions from each test program to form a population of candidate programs. Step 14 then evaluates these candidate programs to identify those which still produce the predetermined event. This evaluation may be simulated or real execution, or take another form. Step 16 discards candidate programs which are evaluated to either not produce the predetermined event or to unpredictably produce that event.

Step 18 determines whether or not there are any candidate programs that produce the predetermined event after the mutation. If there are no such candidate programs that still produce the predetermined event, then step 20 serves to reinstate the previous parent programs as candidate programs that produce the event for another mutation cycle. Alternatively, step 20 is bypassed if at least one candidate event passing in the sense of still producing the predetermined event is detected at step 18. Step 22 detects if the termination conditions for the iterative process have yet been met. These termination conditions may be that no passing candidate test sequences have been identified, that the candidate test sequences have fallen below a predetermined size or that reinstatement of a previous generation of test sequences has occurred a predetermined number of times. If any of these termination conditions is met, then the iterative process terminates. Alternatively, processing proceeds to step 24 where the surviving candidate programs are used to form new parent programs and processing is returned to step 12 for another mutation and evaluation iteration.

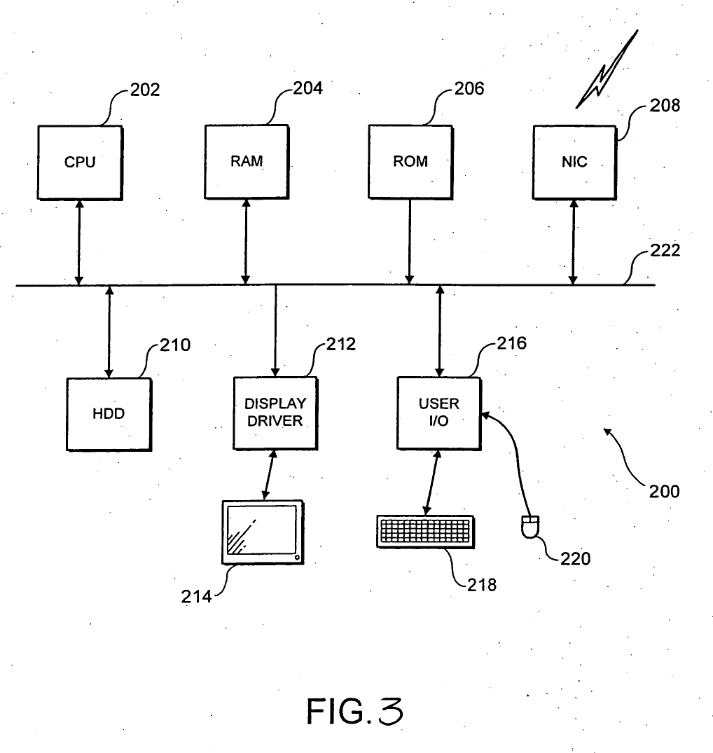

FIG. 3 schematically illustrates a general purpose computer 200 of the type that may be used to implement the above described techniques. The general purpose computer 200 includes a central processing unit 202, a random access memory 204, a read only memory 206, a network interface card 208, a hard disk drive 210, a display driver 212 and monitor 214 and a user input/output circuit 216 with a keyboard 218 and mouse 220 all connected via a common bus 222. In operation the central processing unit 202 will execute computer program instructions that may be stored in one or more of the random access memory 204, the read only memory 206 and the hard disk drive 210 or dynamically downloaded via the network interface card 208. The results of the processing performed may be displayed to a user via the display driver 212 and the monitor 214. User inputs for controlling the operation of the general purpose computer 200 may be received via the user input output circuit 216 from the keyboard 218 or the mouse 220. It will be appreciated that the computer program could be written in a variety of different computer languages. The computer program may be stored and distributed on a recording medium or dynamically downloaded to the general purpose computer 200. When operating under control of an appropriate computer program, the general purpose computer 200 can perform the above described techniques and can be considered to form an apparatus for performing the above described technique. The architecture of the general purpose computer 200 could vary considerably and FIG. 3 is only one example.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A method of analyzing a test sequence of program instructions for an apparatus for processing data, said test sequence producing a predetermined event for said apparatus for processing data, said method comprising:
(i) forming a plurality of copies of said test sequence to serve as parent test sequences;
(ii) removing at least one program instruction from each of said parent test sequences to produce a plurality of candidate test sequences;
(iii) detecting if executing respective candidate test sequences continues to produce said predetermined event for said apparatus for processing data; and
(iv) if at least one of said candidate test sequences continues to produce said predetermined event for said apparatus for data processing, then using said at least one of said candidate test sequences to form parent test sequences; and
(v) repeating steps (ii), (iii) and (iv) until a termination condition is detected.

2. A method as claimed in claim 1, wherein said predetermined event is one or more of:
test failure of said data processing apparatus;
stimulation of a critical path within said data processing apparatus;
power consumption of said data processing apparatus reaching a predetermined level;
a predetermined temporal sequences of events; and
a predetermined concurrent combination of events.

3. A method as claimed in claim 1, wherein said termination condition is one or more of:
no candidate test sequences produces said predetermined event;
said at least one candidate test sequence which continues to produce said predetermined event falls below a predetermined length.

4. A method as claimed in claim 1, wherein if no candidate test sequences produces said predetermined event, then said parent test sequences from a preceding iteration are reinstated and steps (ii), (iii) and (iv) are repeated.

5. A method as claimed in claim 4, wherein said termination condition is reinstatement of said parent test sequences a predetermined number of times without at least one candidate test sequence which continues to produce said predetermined event being found.

6. A method as claimed in claim 1, wherein said at least one program instruction which is removed is a randomly selected program instruction within each parent test sequence.

7. Apparatus for processing data operable to analyze a test sequence of program instructions for an apparatus for processing data, said test sequence producing a predetermined event for said apparatus for processing data, said apparatus comprising logic operable to perform the steps of:
(i) forming a plurality of copies of said test sequence to serve as parent test sequences;
(ii) removing at least one program instruction from each of said parent test sequences to produce a plurality of candidate test sequences;
(iii) detecting if executing respective candidate test sequences continues to produce said predetermined event for said apparatus for processing data; and
(iv) if at least one of said candidate test sequences continues to produce said predetermined event for said apparatus for data processing, then using said at least one of said candidate test sequences to form parent test sequences; and
(v) repeating steps (ii), (iii) and (iv) until a termination condition is detected.

8. A computer program product bearing a computer program for controlling a computer to perform a method of analyzing a test sequence of program instructions for an apparatus for processing data, said test sequence producing a predetermined event for said apparatus for processing data, said method comprising:
(i) forming a plurality of copies of said test sequence to serve as parent test sequences;
(ii) removing at least one program instruction from each of said parent test sequences to produce a plurality of candidate test sequences;
(iii) detecting if executing respective candidate test sequences continues to produce said predetermined event for said apparatus for processing data; and
(iv) if at least one of said candidate test sequences continues to produce said predetermined event for said apparatus for data processing, then using said at least one of said candidate test sequences to form parent test sequences; and
(v) repeating steps (ii), (iii) and (iv) until a termination condition is detected.
